(19) United States
(12) Patent Application Publication
(10) Pub. No.: US 2008/0022815 A1
(43) Pub. Date: Jan. 31, 2008

(54) Firefighter tool

(76) Inventor: Terry C. Farrell, Conneaut Lake, PA (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/493,682

(22) Filed: Jul. 26, 2006

(51) Int. Cl. B25B 7/22; B66F 15/00; B25B 7/02

(52) U.S. Cl. 81/415; 7/137; 7/166

(57) ABSTRACT

A firefighter tool has multiple integrated construction features for accessing and fighting fires in diverse venues, particularly including homes and automobiles. The firefighter tool has pliers, battery cable cutters, a pry wedge, a gas meter flow shut-off wrench, a window breaker, a hammerhead icebreaker and a fire hose flange uncoupling hook. The diverse features are an integrated into a tool of practical construction which is readily commercially manufactured and effectively utilized in fighting fires.

### BACKGROUND OF THE INVENTION

1. Field of the Invention

This invention relates to hand tools. This invention specifically relates to hand tools having multiple functionalities. This invention more specifically relates to a firefighter tool having multiple functionalities.

2. Background of the Prior Art

Firefighter tools having multiple functions are disclosed in USD210,141, granted Feb. 13, 1968 to Woods; USD226,162, granted Jan. 30, 1973 to Zlayele, Jr., USD233,405, granted Oct. 29, 1974 to Frey; USD244,252, granted May 10, 1997 to Ardis; USD281,216, granted Nov. 5, 1985 to Cutliff, Jr, et al.; USD 329,972, granted Oct. 6, 1992 to Calvagno; U.S. Pat. No. 1,561,647, granted Nov. 17, 1925 to Johnson; U.S. Pat. No. 2,360,163, granted Oct. 10, 1944 to Sadler; U.S. Pat. No. 3,599,255 granted Oct. 21, 1968 to Carroll, Sr.; U.S. Pat. No. 3,949,439, granted Apr. 13, 1976 to Ardis; U.S. Pat. No. 4,287,623, granted Sep. 8, 1981 to Tarran; U.S. Pat. No. 4,597,123, granted Jul. 1, 1986 to Cobe, Jr.; U.S. Pat. No. 4,646,378, granted Mar. 3, 1987 to Borden; U.S. Pat. No. 5,105,493, granted Apr. 21, 1992 to Lugtenaar; U.S. Pat. No. 5,428,853, granted Jul. 4, 1995 to Menke; U.S. Pat. No. 6,308,355, granted Oct. 30, 2001 to McMillan et al.; U.S. Pat. No. 6,397,420, granted Jun. 4, 2002 to Roxton; U.S. Pat. No. 6,899,001, granted May 31, 2005 to Sanders et al.; and US Publication 2004/0261188, published Dec. 30, 2004 to Mathis.

In general, such prior art firefighter tools while providing multiple functions suffered one or more of the following impediments: the inability to quickly positively cut cables; the encumbrance of one functional component while using the other functional component; the lack of a useful and comfortable grip for a high leverage pry wedge; the impairment or damage to one functional component during use of another functional component; and the impracticality of the multi tool design for and construction commercial manufacture.

The present invention provides a solution to the foregoing prior art impediments, and does so in a comprehensive firefighter tool.

It is therefore a principal object of the present invention to provide a hand tool particularly including a firefighter tool with multiple functionalities.

It is another principal object of the present invention to provide a firefighter tool as aforesaid wherein each function is readily comfortably performed without interference with or impairment to the other functions or functional components.

It is another object of the present invention to provide a firefighter tool with multiple diverse functions for accessing fires in both a home and an automobile.

It is another object of the present invention to provide a firefighter tool as aforesaid having cable cutting functionality.

It is another object of the present invention to provide a firefighter tool as aforesaid having improved pry wedge construction and use.

It is still a further object of the present invention to provide a firefighter tool as aforesaid having an improved construction for breaking ice away from a firehouse coupling.

It is another object of the present invention to provide a firefighter tool as aforesaid having an integral positive acting gas meter valve shut-off construction function, and particular one that is readily commercially manufactured.

It is still a further object of the present invention to provide a firefighter tool as aforesaid having an improved fire hose coupling engagement construction.

It is yet another object of the present invention to provide a multiple function hand tool, particularly including a firefighter tool, of practical design and construction, and practical in commercial manufacture.

### SUMMARY OF THE INVENTION

The firefighter tool combines diverse construction elements for accessing and suppressing fires in diverse venues particularly including homes and automobiles.

In another aspect, the firefighter tool provides an improved pry wedge for high leverage action, particularly in prying open windows to access homes.

In another aspect, the firefighter tool provides a pliers' configured cable cutter.

In another aspect, the firefighter tools provides a hammerhead for breaking ice on a fire hose coupling, and a complimentary hook for then engaging the fire hose coupling flange for ready uncoupling. The use of the uncoupling flange engagement function does not impair or damage the other construction features or elements.

In still another aspect, the firefighter tool provides a specifically designed polygonal wrench for engaging and shutting off a home gas flow meter valve, and a complimentary high leverage wedge for prying a window open for access to the home after securing the gas flow.

In one preferred aspect, the firefighter tool has two pivotably connected members with distally disposed jaws having a cable cutting function, and two proximately disposed handles with diverse complementary constructions and functions. One handle has a specially designed polygonal wrench for shutting off the home gas flow meter valve, and further includes an adjacent wedge for prying a home window open after the gas flow is secured. The pry wedge is used by pressing down on extended surface area planar surfaces disposed on the pliers' jaws to apply a high leverage force to the oppositely disposed wedge edge. The other handle has a hammerhead for breaking ice away from a fire hose coupling, and further includes a hook and juxtaposed contoured handle for contactingly engaging the fire hose coupling to apply torque for readily uncoupling the fire hose. The hook and contoured handle are formed to engage differently sized fire hose couplings.

In another preferred aspect, the firefighter tool has a first member with a proximately disposed first handle and a distally disposed first jaw;

a firefighter tool that includes a first member having a proximately disposed first handle and a distally disposed first jaw, and a second member having a proximately disposed second handle and a distally disposed second jaw with a pivotable connection connecting the members comprising a pivot axis disposed between the handles and jaws so that the handles pivotably move the jaws from an open position to a closed position, a wedge formed at the proximate end of the first handle, and the wedge has an elongate edge transversely disposed to said pivot axis, and further including a foot or lug formed on the first handle, whereby with the jaws in the closed position the user grips the tool adjacent the means for pivotably connecting the members and applies a force so that the foot or lug contactingly engages a surface and a resultant leverage force is applied to the wedge edge, a second member with a proximately disposed second handle and a distally disposed second jaw; and further including means for pivotably connecting the members with a pivot axis, disposed between the handles and jaws so that the handles pivotably move the jaws from an open position to a closed position; and further includes a wedge formed at the proximate end of the first handle, having an elongate edge transversely disposed to the pivot axis. The firefighter tool, when in the pivoted closed position, permits the user to grip the extended planar surfaces adjacent the means for pivotably connecting the members. The firefighter grips the tool accordingly and presses downwardly on the extended planar surfaces to apply a high leverage force to the wedge edge.

Whereas the pliers art consistently teaches one to grasp the handles and not the jaws, the present invention, in one broad aspect, finds that certain closed pliers jaws having extended surfaces provide a useful and comfortable grip in conjunction with operable construction elements disposed at the proximate ends of the handles. This is particularly so for a proximately disposed pry edge, which is transversely disposed to the pliers jaws pivot axis. More specifically, it has been found that with the jaws closed, a specific minimum planar surface area provides a relatively comfortable grip. An extended planar surface area of least about 2.25 sq. in., and preferably at least about 2.25 to 2.50 sq. in., was found to provide an effective and comfortable grip portion for proximate end tool elements.

### BRIEF DESCRIPTION OF THE DRAWINGS

FIG. 1 is a bottom plan view of the firefighter tool in use in engaging a fire hose coupling;

FIG. 2 is a top plan view of the firefighter tool of FIG. 1 with cross-hatching designating extended planar surfaces adjacent the distal end;

FIG. 3 is a bottom plan view of the firefighter tool of FIG. 1 in the open positions;

FIG. 4 is a top perspective view of the firefighter tool of FIG. 1; and

FIG. 5 is an enlarged fragmentary sectional view of the mid region of the wedge as shown in FIG. 2.

### DESCRIPTION OF THE INVENTION

Referring to the FIGS., there is shown the firefighter tool 10 of the present invention. Firefighter tool 10, in broad terms, includes two members 11 and 12 pivotally connected by pivot member 50 having pivot axis A. Members 11 and 12 have respective proximately disposed handles 13 and 14, and respective distally disposed jaws 15 and 16. The handles 13, 14 and jaws 15, 16 pivot with respect to pivot member 50.

Handle 13 has inner edge 17, an outer edge 18 and proximate end surface 19. Inner edge 17 is formed with proximately disposed hammerhead 20. Hammerhead 20 extends away from handle 13 towards handle 14, for purposes hereinafter appearing. Outer edge 18 is formed with hook 21. Hook 21 extends distally from proximate end surface 19 and terminates in tapered end 23. Outer edge 18 is also formed with curvilinear recess 22, which is somewhat distally disposed from hook end 23, for purposes hereinafter appearing.

Handle 14 is formed with a proximately disposed wedge 25. Wedge 25 terminates in tapered pry edge 26. Pry edge 26 is transversely disposed to pivot axis A of pivot member 50, for reasons hereinafter appearing. Wedge 25 has a top surface 27, a curvilinear bottom surface 28, pry edge 26 and an elongate irregular hexagonal through hole 30. Through hole 30 extends from surface 27 to surface 28, and has tapered sidewalls 30a-30f, for purposed hereinafter appearing.

Handle 13 is also formed with a proximately extending cylindrical projection member 31 having a sharpened point 32, for purposes hereinafter appearing.

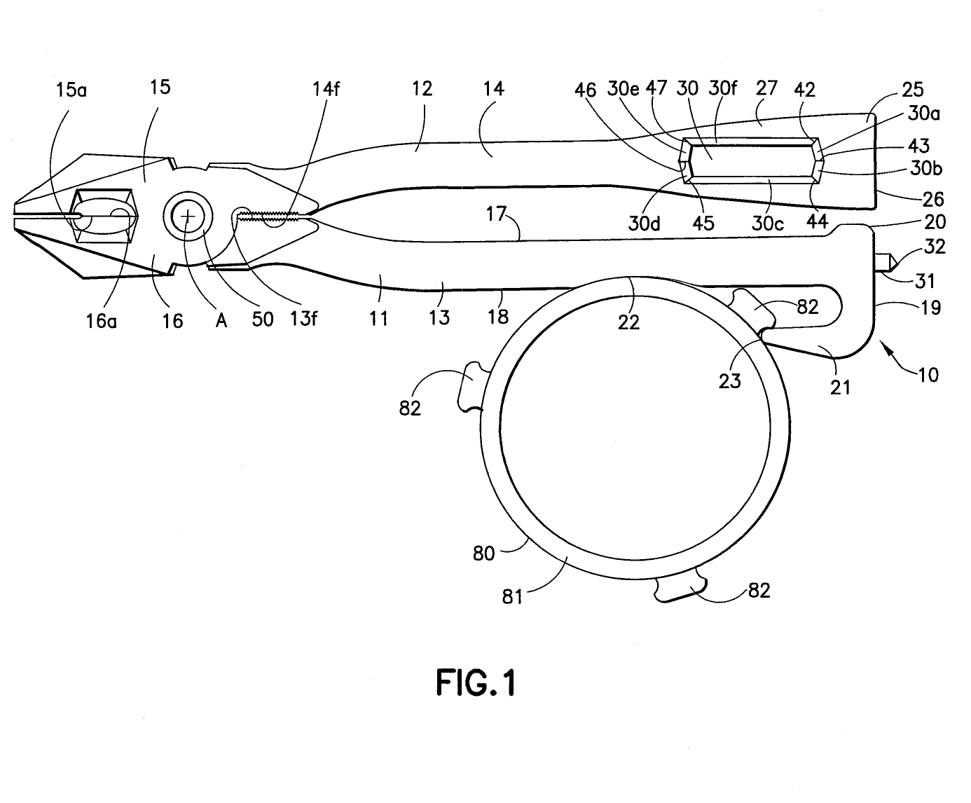

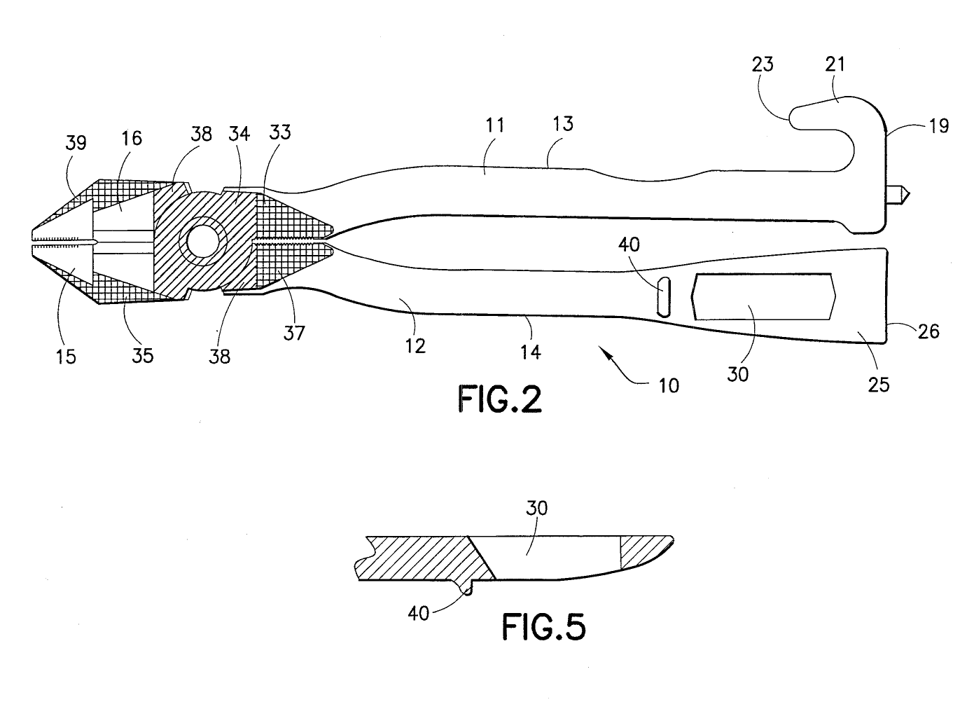

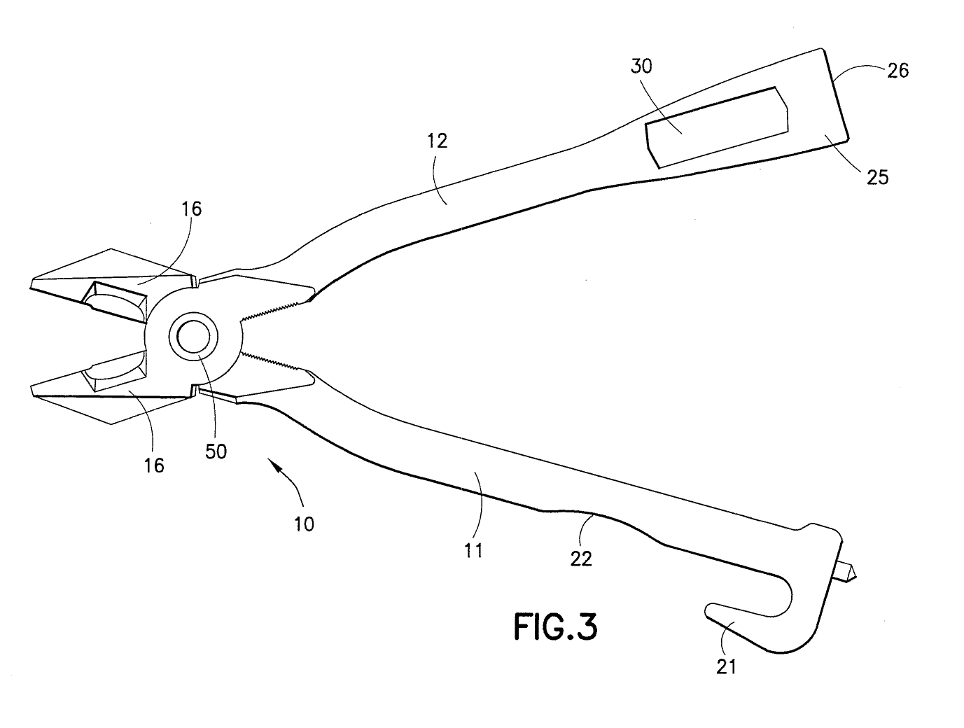

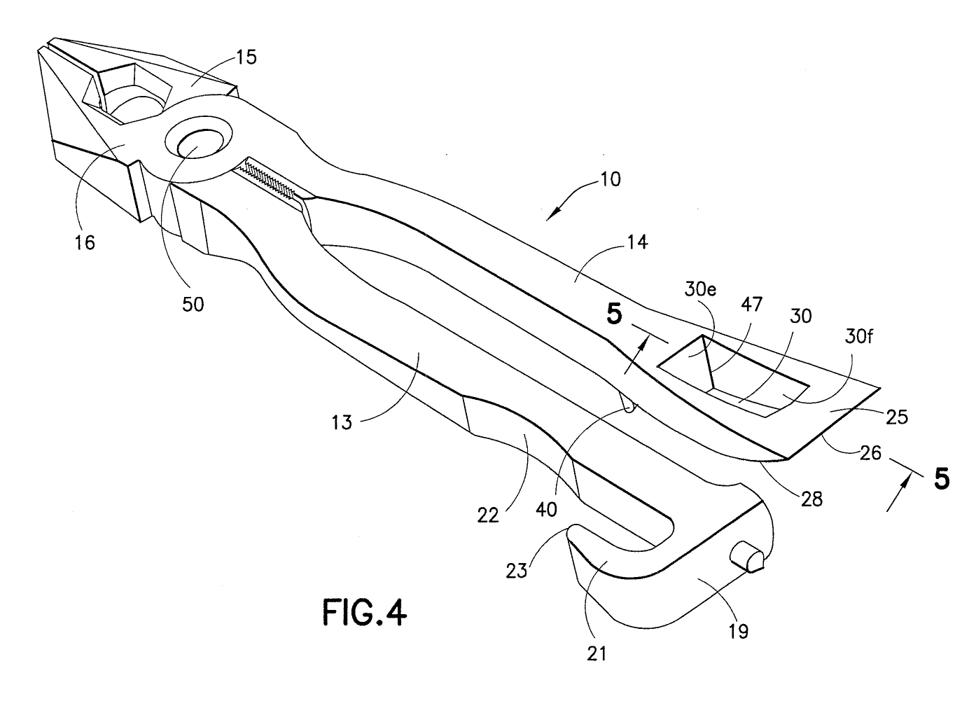

Referring specifically to FIG. 2, there is shown the lined bottom extended surfaces of the jaws. The upper surfaces of the jaws are similar (FIG. 1). Handle 13 has a distally disposed first extended planar surface 33, a second extended planar surface 34, and a third extended planar surface 35. Surfaces 33 and 34 are coplanar. Surface 35 is obtusively angled with respect to immediately adjacent surface 34. Again referring specifically to FIG. 2, handle 14 has a distally first disposed extended planar surface 37, a second planar surface 38 and immediately adjacent obtusively angled planar surface 39. In this manner of construction, the total surface area of extended planar surfaces corresponding to the lower extended surfaces 33, 34, 35, 37, 38 and 39 is at least about 2.25 sq. in., and preferably at least about 2.25 to 2.50 sq. in. With the jaws in the closed position, the firefighter grips jaws 15, 16 and the palm, in particular, contactingly engages the top extended surfaces 33, 34, 35, 37, 38 and 39. The firefighter inserts wedge pry edge 26 into, e.g. a closed window edge and exerts a downward force on the like aforesaid extended upper surfaces (FIG. 1) area to in turn provide a high leverage force to the wedge pry edge to readily open the closed window.

Referring specifically to FIGS. 2 and 5, there is shown the bottom of handle 14. A transversely disposed elongated foot or lug 40 is formed on the bottom of handle 14. Lug 40 is adjacent to through hole 30. Lug 40 is formed with a curved or rounded end. In this manner of construction, the user inserts wedge edge 20 at the bottom of a closed window (not shown) and rests the rounded end of lug 40 on a sill or other adjacent surface (not shown) and in gripping the jaws, exerts a downward force. Lug 40 improves the assertion of a leverage force on the wedge edge.

Referring specifically to FIG. 1, there is shown a fire hose coupling 80, as shown in FIG. 1, having a cylindrical outer surface 81 and three equally spaced radially outwardly protruding lugs 82 of conventional construction. The coupling 80 is a 4 in. conventional firehouse coupling. A conventional 2 in. conventional firehouse coupling (not shown) may likewise be accommodated by tool 10. Handle 13, and specifically curvilinear recess 22 is configured so that a substantial portion of surface 81 is received in and contactingly engages recess 22. Where tool 10 is utilized to uncouple a 2 in. hose, a lesser portion of the 2 in. cylindrical surface (not shown) contactingly engages recess 22. Hook 21 is configured to engage a 4 in. or a 2 in. coupling lug (not shown). That is, the present tool is operable with differently sized standard fire hose couplings.

Through hole 30 is of elongate irregular hexagonal construction having sidewalls 30a-30f and corresponding corners 42, 43, 44, 45, 46 and 47. Through hole 30 is sized to slidably engage the handle of a standard home gas flow meter flow valve to provide a wrench function (not shown). The firefighter grips the closed jaws, particularly including the extended surfaces 33, 34, 35, 37, 38 and 39, and engages the gas flow valve handle in hole 30. The firefighter rotates to the tool to close the valve to shut off the gas flow. This is undertaken prior to entry through the pry bar opened window as afore-discussed. It has been found that by providing a tapered irregular hexagonal through hole in contradistinction to rectilinear through hole, the wedge may be readily manufactured in a combination fire. That is, less force is required to punch the slightly hexagonal sheet, in the handle as shown, during the operation. A conventional commercially available combination die may therefore be used, such as shown in FIG. 8-115 “Fundamental of Tool Design”, Society of Manufacturing Engineering. This is one of the several features that make the present tool both readily operable and manufactured, and a consequently commercially viable.

It has been found that by providing a series of adjacent or contiguous extended planar surfaces surrounding the pivot member and on the jaws, the extended planar surfaces be used as an effective and comfortable handle for using proximately disposed tool elements, particularly including the pry wedge. It has been found that when the foregoing upper planar surfaces corresponding to the lower planar surfaces have a minimal extended surface area of at least about 2.25 sq. in., and preferably at least about 2.25 to 2.50 sq. in, an effective comfortable grip is achieved with the jaws closed.

Jaws 15,16 are formed with respective edges 15a, 16a for cutting a cable such as an automatic battery cable to disarm the battery before fighting the automobile fire. Handles 13, 14 are formed with opposed serrated edges 13f, 14f for gripping a cable or hose (not shown) to further assist the firefighter.

In the aforesaid manner of construction, the firefighter, in accessing a home fire, grips the jaws distal end planar surfaces and uses the hexagonal wrench to engage and shut-off the home gas meter valve, and then grips the tool at the planar surfaces and engages a closed window edge with the pry wedge and exerts a downward force to leverage the wedge edge against the window edge to open the window to thereby gain entry to the home with the gas flow shut off.

In the aforesaid manner of construction, the firefighter may also use the hammerhead to break away ice from the fire hose coupling and then use the oppositely disposed hook to engage the coupling flange and readily uncouple the ice free fire hose.

In the aforesaid manner of construction, the firefighter can use the pliers' jaws to cut the battery cables of an automobile and then use the proximate end projection to break the automobile window to thereby gain access to the fire.

A multipurpose firefighter tool has been illustrated and described. Various modifications and/or substitutions of the specific components described herein may be made without departing from the scope of the present invention. Various modes of carrying out the invention are contemplated as being within the spirit and scope of the invention as defined in the following claims, which particularly point out and distinctly claim the subject matter of the invention.

1. A firefighter tool comprising:
a first member comprising a proximately disposed first handle and a distally disposed first jaw;
a second member comprising a proximately disposed second handle and a distally disposed second jaw;
means for pivotably connecting the members comprising a pivot axis, and being disposed between the handles and jaws so that the handles pivotably move the jaws from an open position to a closed position; and
a wedge formed at the proximate end of the first handle, said wedge comprising an elongate edge perpendicularly disposed to said pivot axis, said tool comprises a center line disposed through said pivot axis, said elongate edge being adjacent to and in perpendicular disposition with said center line with the jaws in the closed position, said wedge being operably disposed in said closed position;
whereby in the closed position the user grips the tool adjacent the means for pivotably connecting the members and applies a leverage force to the wedge edge.

2. The firefighter tool of claim 1, further comprising a grip portion comprising an extended upper surface portion of one of said jaws for gripping said tool for said wedge leverage use, said extended upper surface portion being disposed adjacent the means for pivotably connecting the members.

3. The firefighter tool of claim 1, further comprising a grip portion comprising an, extended surface portion comprising a first extended planar surfaces and second extended planar surfaces angularly juxtaposed to and contiguous with the first extended planar surfaces for engaging the hand and particularly the palm of the user, and wherein the total surface area of said first extended surfaces and said contiguous second extended surfaces is at least about 2.25 sq. in.

4. The firefighter tool of claim 1, said wedge comprises a polygonal through opening sized for encompassing and contactingly engaging a home gas meter valve.

5. The firefighter tool of claim 1, said second handle comprises a hammerhead having a strike face facingly disposed to said first handle when in the closed position, whereby when the user hammers with the strike face with the jaws open, the jaws are urged towards the open position thereby preventing jaws contact and consequential damage to the jaws during the hammering.

6. The firefighter tool of claim 4, said through hole extends in the same direction as said pivot axis.

7. The firefighter tool of claim 1, further comprising a grip portion disposed adjacent the means for pivotably connecting the members, said grip portion comprises a first extended planar surfaces area for engaging the palm of the user.

8. The firefighter tool of claim 7, said grip portion further comprises a second extended planar surfaces immediately juxtaposed to said first and second first planar surfaces, said planar surfaces being disposed in about the same plane.

9. The firefighter tool of claim 1, said second handle comprises oppositely disposed edges, one edge being formed with a hook and the other edge being formed with a hammerhead, said hammerhead strike extends away from the said other edge towards and facingly disposed to the first handle when in the closed position.

10. The firefighter tool of claim 8, said second planar surface being disposed on at least one of said jaws.

11. A firefighter tool comprising:
a first member comprising a proximately disposed first handle and a distally disposed first jaw;
a second member comprising a proximately disposed second handle and a distally disposed second jaw;
means for pivotably connecting the members comprising a pivot axis, and being disposed between the handles and jaws so that the handles pivotably move the jaws from an open position to a closed position;
a wedge formed at the proximate end of the first handle, said wedge comprising an elongate edge perpendicularly disposed to said pivot axis said tool comprises a center line disposed through said pivot axis, said elongate edge being adjacent to and in perpendicular disposition with said center line with the jaws in the closed position, said wedge being operably disposed in said closed so that in the closed position the user grips the tool adjacent the means for pivotably connecting the members and applies a force to leverage the wedge edge for opening a window;
a hook formed at the proximate end of the second handle, said hook extends distally from the second handle proximate end, and being formed to engage a fire hose coupling flange, said second handle being formed with a curvilinear recess facing disposed to said hook, said curvilinear recess having a radius of curvature sized to receive the circumferential surface of a fire hose coupling;
whereby the firefighter grips the tool and uses the hook to engage the fire hose coupling flange with the curvilinear recess receiving the fire hose coupling cylindrical surface, and the firefighter thereby uncouples the fire hose.

12. The firefighter tool of claim 11, said second handle having an outer edge and an inner edge, said hook being disposed on the outer edge.

13. The firefighter tool of claim 12, said second handle inner edge being formed with a hammerhead having a planar strike surface, said strike surface being facingly disposed to said first handle in the closed position.

14. The firefighter tool of claim 11, said jaws comprise opposed elongate edges formed for cutting a cable.

15. The firefighter tool of claim 14, said handles comprise opposed edges for griping a work piece disposed proximately from the means for pivotably connecting the members.

16.-26. (canceled)

27. The firefighter tool of claim 3, said first and second planar surfaces subtend an obtuse angle.

28. The firefighter tool of claim 3, wherein the total surface area of said angularly disposed planar surfaces is at least about 2.25 square inches.

29-33. (canceled)

34. A firefighter tool comprising:
a first member comprising a proximately disposed first handle and a distally disposed first jaw;
a second member comprising a proximately disposed second handle and a distally disposed second jaw;
means for pivotably connecting the members comprising a pivot axis, and being disposed between the handles and jaws so that the handles pivotably move the jaws from an open position to a closed position;
a wedge formed at the proximate end of the first handle, said wedge comprising an elongate edge perpendicularly disposed to said pivot axis, said tool comprises a center line disposed through said pivot axis, said elongate edge being adjacent to and in perpendicular disposition with aid center line with the jaws in the closed position, said wedge being operably disposed in the closed position; and
a foot disposed on the first handle, said first handle comprises an upper surface and a lower surface, and said foot being disposed on the lower surface, said foot being elongate and transversely disposed to said pivot axis;
whereby with the jaws in the closed position the user grips the tool adjacent the means for pivotably connecting the members and applies a leverage force so that the foot contactingly engages a surface and a resultant leverage force is applied to the wedge edge.

35-36. (canceled)

37. The firefighter tool of claim 34, said wedge comprises a polygonal through opening sized for encompassing and contactingly engaging a home gas meter valve.

38. The firefighter tool of claim 37, said polygonal through opening being disposed between said foot and said wedge edge.

39. The firefighter tool of claim 1, said second handle comprises a hammerhead having a strike face facingly disposed to said first handle when in the closed position, whereby when the user hammers with the strike face, the jaws are urged towards the open position thereby preventing jaws contact and consequential damage to the jaws during the hammering.

40. The firefighter tool of claim 34, wherein said foot and said wedge edge are in parallel disposition.
